(19) United States
(12) Patent Application Publication
(10) Pub. No.: US 2001/0001787 A1
(43) Pub. Date: May 24, 2001

(54) GRANULATION METHOD FOR DIRT-DISSOLVING, AMPHIPHILIC POLYMERS BY COMPRESSED AGGLOMERATION

(75) Inventor: HERBERT KOCH, DORSTEN (DE)

Correspondence Address: C JAMES BUSHMAN, BROWNING BUSHMAN, 5718 WESTHEIMER, SUITE 1800, HOUSTON, TX, 77057

(73) Assignee: Herbert Koch

(21) Appl. No.: 09/308,989

(22) PCT Filed: Oct. 17, 1997
(86) PCT No.: PCT/EP97/05746

§ 371 Date: None

(30) Foreign Application Priority Data
Nov. 27, 1996 (DE) 19649119.3

(51) Int. Cl. C11D 1/00

(52) U.S. Cl. 510/470

(57) ABSTRACT

The invention relates to a method of granulating amphiphilic soil release polymers by press agglomeration and to the use of the granules for producing solid detergents and cleaning products.

The invention relates to a method of granulating amphiphilic soil-release polymers by press agglomeration and to the use of these granules for producing solid detergents and cleaning products.

The compilation of formulations for detergents and cleaning products is a complex task, since the formulations must be capable of removing soiling of a wide variety of types from very different surfaces. The rapid and efficient removal of fatty or greasy soiling, in particular, is generally a problem. In addition to those requirements relating purely to the cleaning effect, the ecotoxicological requirements based on formulations for detergents and cleaning products are becoming ever more stringent.

Treating natural resources sparingly is a matter not only of using surfactants based on renewable raw materials but also, quite particularly, of producing formulations which are increasingly effective at a fixed level of raw materials use. In addition, the surfactant-containing formulations for detergents and cleaning products, which are becoming more and more compact, must be rapidly soluble in water even when the amount of water in the washing liquor is falling, again for environmental reasons.

The totality of these requirements can no longer be met by physical means alone but requires the use of more powerful formulations with new ingredients which, where possible, should be multifunctional.

The group of these multifunctional detergent ingredients includes the soil-repellent or soil release polymers (in German: Schmutzlösepolymere).

As a constituent for formulations, soil release polymers contribute to more ready detachment of oil and grease stains. A feature of soil release polymers is that they possess both hydrophilic and hydrophobic structural units (amphiphilic polymers). The mode of action of soil release polymers is based, inter alia, on the modification of the fiber surface of polyester fabrics and cotton/polyester blend fabrics with the aid of the hydrophilicizing polymer. In this case the hydrophilic segment of the soil release polymer brings about greater ease of wetting of the surface, while the hydrophobic segment functions as an anchor group.

Moisture transport (water absorption and absorbency) in the hydrophobic fabrics, such as polyester or polyester/ cotton blends treated with the soil release polymer, is considerably improved. Furthermore, such polymers give the materials antistatic and slip properties, thereby facilitating the handling of these fibers on cutting and sewing (textile processing). Treatment of the fabric with the soil release polymer can be considered as a kind of impregnation, i.e. the soil release polymer remains on the fibers for a number of wash cycles.

Soil release polymers, in addition to their soil-repellent or soil release properties and their antiredeposition capacity (inhibition of grayness), also have surface-active properties. This surfactant character (polymer surfactant) brings about a synergy with the surfactants employed in the formulation, thereby making it possible to increase the washing power considerably. It is by virtue of the multifunctional character of the soil release polymers that the cleaning action of formulations equipped with these polymers can be considerably increased.

The most important group of soil release polymers includes polyesters and oligoesters based on terephthalic acid/polyoxyalkylene glycols/monomeric glycols.

Soil release polymers from this group have been on the market for a number of years already. The principal commercial products include ZELCON (DuPont), MILEASE T (ICI), ALKARIL QCF/QCJ (Alkaril Inc.) and REPEL-O-TEX (Rhone-Poulenc).

One of the effects of these compounds is to prevent dissolved dirt from resettling on the fabric and thus leading to graying.

The German patent DE 28 57 292 describes detergents which as soil-repellent compound comprise a polymer of ethylene terephthalate and polyoxyethylene terephthalate and also anionic surface-active agents in the form of nonethoxylated alcohol sulfates, alcohol sulfates condensed with ethylene oxide, and mixtures thereof.

The European patent application EP 0 365 103 describes a surfactant composition containing an organic, nonionic surfactant which comprises from 4 to 30% by weight of a synthetic, organic, nonionic surfactant, from 25 to 80% by weight of builders, from 0.1 to 2% by weight of protease, from 0 to 2% by weight of amylase, from 0.2 to 1% by weight of cellulase, from 1 to 15% by weight of water and, as a further constituent, poly(alkylene glycol terephthalate).

The EP applications 0 185 427, 0 241 984, 0 241 985 and 0 272 033 disclose polyester condensates of polybasic aromatic carboxylic acids with dihydric alcohols and with polyethers that are C1-C4-capped at one end, which promote the release of soiling from polyester fabrics. These polyesters have hydrophilic end groups which in the cited applications are specified as a prerequisite for the soil release properties of the polyesters.

In addition to this class of soil release polymers, the literature also describes cellulose derivatives. Such products are, moreover, commercially available, for example as hydroxy ethers of cellulose under the product designation METHOCEL (Dow).

To incorporate the amphiphilic polymers into pulverulent detergents and cleaning products, a variety of techniques are employed.

One widespread use form comprises aqueous solutions or dispersions of the amphiphilic polymers, which are incorporated into the detergent formulations. A disadvantage of this use form is the low active substance content of the dispersions, since in aqueous solution the amphiphilic polymers have a very great tendency to thicken, with the result that, owing to the high viscosities, it is possible to process only dispersions with concentrations of 20-25%.

A further disadvantage of this use form is the hydrolytic sensitivity of the polyesters, which, when they are processed under alkaline conditions and at elevated temperature, leads to a loss of performance of the polymers.

A further option for introducing the polymers into pulverulent detergents and cleaning products comprises granules of the polymers with finely divided carrier materials. DE 44 08 360 describes a process for producing such granules, which comprises heating solid, soil-releasing polymers that are solid at room temperature and contain ethylene terephthalate and polyoxyethylene terephthalate groups, to a temperature at which the polymers have viscosities of below 5000 mPas, and applying the polymer melts to the finely divided carrier material in a compacting mixer at a mixing temperature which is at least as high as the softening temperature of the polymers, or to a fluidized bed of the carrier material at a mixing temperature which at most is as high as the softening temperature of the polymers.

A decisive parameter for the production of granules by this process is the melt viscosity of the polymers employed. In order to establish viscosities below 5000 mPas, it is often necessary to heat the polymers to temperatures of 100-120° C. or more. Since in the majority of cases the polymers have a tendency to undergo autoxidation, granulation must be carried out under an inert gas atmosphere, necessitating increased technical expense. Because of the coating of the finely divided carrier materials with molecular oxygen, autoxidation of the polymers can in many cases not be ruled out even when inert gas is used, and leads to an unwanted discoloration (yellowing) of the granules.

DE 22 49 812 describes a process in which mixtures of amphiphilic polyesters and extrudable organic solids are ground with one another in solid form and then the mixture is extruded and the extrudate is shaped, if desired, to form granules.

Mixtures of amphiphilic polyesters and polycarboxylates are known from DE 35 31 755 which are obtainable by mixing melted polyesters with a polyacrylate, cooling the mixture and comminuting the resultant solid product to the desired particle size by cryogenic methods. The material is comminuted at temperatures below 0° C. The coolant used for this purpose is liquid nitrogen or solid carbon dioxide.

DE 44 41 189 describes a process for producing finely divided mixtures of amphiphilic polymers and inorganic solids, which comprises heating amphiphilic polymers whose softening temperature is above 35° C. and at least one inorganic solid to a temperature which is above the softening temperature of the polymer, mixing the components at this temperature, and then fragmenting the mixture and rapidly cooling the fragments in such a way that almost no separation can occur and then, if desired, comminuting the mixture at temperatures below 50° C. to the particle sizes that are customary in detergents.

In a preferred embodiment, the polymers are mixed at temperatures of 80-200° C. with the inorganic carrier materials and this mixture is then conveyed on a cooling belt. Since the resultant pellets are unsuitable for direct use in detergents and cleaning products, they must be comminuted to the desired particle sizes, for example from 50 μm to 5 mm. Depending on the polymer employed, this operation must be carried out under cryogenic conditions.

A disadvantage of this process is the relatively high energy consumption required both to cool the mixture of polymer melt and inorganic carrier material from temperatures of around 140° C. to below 10° C. and to grind the resultant pellets, possibly under cryogenic conditions, to the desired particle size.

DE 195 06 634 describes a further method of formulating amphiphilic polymers, which features the mixing of an aqueous dispersion or colloidal aqueous solution of at least one amphiphilic polymer with an aqueous solution of a polycarboxylate and the processing of the dispersions thus obtainable by spray drying to form a finely divided polymer mixture.

A disadvantage of this process is again the relatively high energy consumption necessary for the operation of spray drying.

The majority of the prior art processes for producing pulverulent granules of amphiphilic polymers have the disadvantage that relatively large amounts of carrier substances are required in order to produce storage-stable easy-flow granules.

The object of the present invention, therefore, is to provide a method of granulating amphiphilic soil release polymers which is unhampered by the disadvantages of the formulation techniques set out above. Furthermore, the intention with the method according to the invention is to produce granules that are notable for a narrow particle size spectrum, high mechanical strength and thus good storage stability. In addition, the granules should have quite high contents of active substance and should be readily dispersible under normal washing conditions.

This object is achieved in accordance with the invention by a method of granulating amphiphilic soil release polymers, in which with the aid of so-called press agglomeration the amphiphilic polymers, which become pastelike on gentle heating, and/or mixtures of the amphiphilic polymers with inorganic carrier substances are converted into granules.

The invention therefore provides a method of granulating amphiphilic soil release polymers by press agglomeration. It additionally provides for the use of the granules thus prepared for producing solid detergents and cleaning products.

The process of press agglomeration is preferably conducted on a circular or annular die press.

In such a press, the circular or annular die rotates around pressing rollers (stators) which are fixed in the internal chamber. From the mixing drum, which is upstream of the annular die press, the amphiphilic polymer and/or mixtures of the polymer with inorganic carrier substances and, if desired, with other additives is conveyed by means of a conveyor into the internal chamber of the rotating annular die, where it is compacted by the pressing rollers and is rolled into the shaping channels. On repeated circulation of the annular die, the individual moldings form agglomeration strands which under the prevailing centrifugal force are torn away from the rotating die.

Given the appropriate selection of shaping channels in the annular die it is possible to establish the thickness of granule required for the detergent sector. The cylindrical granules can be cut to a desired length. The granules are then passed to a cooling section in order to dissipate the heat introduced into the product in the course of shaping. The function of this cooling section can be fulfilled, for example, by a fluidized bed, in which, simultaneously, classification of compacted material and fine fractions takes place. Powder which has not been compacted, and abraded product, can be separated off at this point and recycled.

The cylindrical granules produced by the method according to the invention can, if desired, be rounded. Rounding can be done using known means such as, for example, Marumerizers.

It is possible if desired to apply a powder to the surface of the granules in order to improve further their storage stability. This surface charge can be applied using pulverulent zeolites, especially detergent-grade zeolite NaA, talc, silicic acids and the like.

A further possibility is to incorporate additional additives in the upstream mixing drum which enhance the dispersion of the granules in the washing process, such as disintegrants, for example. The literature describes a large number of additives which increase the solubility or dispersibility of granules. As representative of the additives mention may be made at this point of bentonite.

Fundamentally, there exist various possibilities for introducing the amphiphilic polymer or mixtures of amphiphilic polymer with inorganic carrier substances into the process of press agglomeration.

One possible technique is to grind (perhaps cryogenically) or to coarsely comminute the amphiphilic polymer obtained in the production process and to introduce the pulverulent polymer or coarsely comminuted polymer into the compression shaping process. In this process the product may optionally be treated beforehand with additives or inorganic carrier substances. Additives which accelerate the dispersion of the granules in the washing process are preferably added to the ground polymer.

A further alternative is to convey the amphiphilic polymer melt obtained in the production process on a cooling belt and to produce from it pellets which are subsequently processed further in the press agglomeration process of the invention. As described in DE 44 41 189, it is also possible to mix the amphiphilic polymer, at a temperature above that at which it softens, with inorganic carrier substances, to fragment the melt, with the aid of a cooling belt, for example, and from these fragments, by rapid cooling to a temperature at which virtually no separation can occur, to produce pellets which again are supplied to the press agglomeration process.

In addition to the formation of pellets (pelletizing), the melt of an amphiphilic polymer can also be converted, with the aid, for example, of a cooling roll, into flakes, which once again are employed in the agglomeration step of the invention.

Another possibility is to supply the melt of an amphiphilic polymer, directly or after blending with inorganic carrier substances and/or other additives, to a press agglomeration process.

Amphiphilic polymers that are particularly suitable for the process step of press agglomeration in accordance with the invention are those which are readily dispersible in water and which are also easy to plasticate. The thermoplastic processability of the amphiphilic polymers and/or of their mixtures with carrier substances and/or other additives plays a critical part here.

In this context, amphiphilic polyesters that are suitable to a particular extent are those comprising terephthalic acid groups as units. Particularly preferred polyesters here are those comprising units of (a) ethylene terephthalate and (b) polyoxyethylene terephthalate of polyethylene glycols having molar masses (M_{w}) of 500-10,000.

Amphiphilic polymers of this kind are the subject of a series of applications.

DE-A-14 69 403 describes a process for the surface-modifying treatment of articles derived from polyesters. In this process the polyesters produced are composed of ethylene terephthalate units (ET) with ET: POET ratios of 2-6:1, using polyethylene glycols having (weight-average) molar masses of 1000-4000 (POET-polyoxyethylene terephthalate).

U.S. Pat. No. 4,427,557 and EP-A-0 066 944 describe anionic modifications of the above polyesters comprising, as a further polymerization component, the sodium salt of sulfoisophthalic acid. The polymerized polyethylene glycols (PEGs) possess molar masses of 200-1000 and, following their polymerization with ethylene glycol (EG) and terephthalic acid, give rise to polyesters having molar masses of 2000-10,000.

U.S. Pat. No. 3,959,230 claims ET/POET polyesters with ET:POET ratios of 25:75-35:65, where low molecular mass polyethylene glycols having molar masses of 300-700 are employed and the polyesters obtained have molar masses of 25,000-55,000.

EP-A-0 253 567 and EP-A-0 357 280 also describe, in particular, endgroup-capped polyesters which are capped on the one hand by nonionic groups such as, for example, C1-C4-alkyl, C1-C4-hydroxyalkyl, C1-C4-acyl and also by ionic succinate groups.

A further class of amphiphilic polymers which come preferably into consideration are polyesters known from the DE application P 196 20 094. Here, soil-repelling amphiphilic polymers are described which can be represented by the following empirical formula:

(CAP)ₓ(T)_{z}(I)_{q}(CAR)ᵣ(DEG)ₛ(En)ₜ(A)_{y}(EG/PG)_{w} (I)

in which

(CAP) represents endgroups which cap the polymer at the end and

a.) sulfoaroyl groups

b.) groups with the formula MO₃—S—(O)ᵤ—(CH₂)ₚ—(RO)ᵥ—, in which M is a metal atom and R is ethylene or mixtures of ethylene and propylene, u is 0 or 1, p is 0 or 1 and v is from 1 to 100,

c.) poly(oxyethylene) monoalkyl ether groups in which the alkyl group contains from 1 to 24 C atoms and the polyoxyethylene group consists of 2 to 200 oxyethylene units,

d.) acyl and aroyl groups having 4 to 40 carbon atoms,

e.) hydroxyacyl and hydroxyaroyl groups having 2 to 25 carbon atoms,

f.) poly(oxyalkylene) monoalkylphenol ethers, in which the alkyl group contains 6 to 18 carbon atoms and the polyoxyalkylene group consists of 0 to 80 oxyalkylene units, or

g.) mixtures thereof

and x represents values from 0 to 2,

(T) represents an arylenedicarbonyl group and z represents a number from 1-50,

(I) represents an internal anionic group and q represents a number from 0 to 30,

(CAR) represents a carbonyl group of a carbonate unit and r represents a number from 1 to 80,

(DEG) represents di(oxyethylene)oxy and s represents a number from 1 to 80,

(En) represents a poly(oxyalkylene)oxy group composed of 2 to 100 oxyalkylene groups, where t is a number from 0-25 and the alkyl groups contain 2 to 6 C atoms,

(A) represents a 1,n-alkylenedicarbonyl group which is composed of 2 to 24 C atoms, and y is a number from 0 to 15,

(EG/PG) represents an oxyethyleneoxy or oxypropyleneoxy group or mixtures thereof and w represents a number from 0 to 80, and where the oligoesters/polyesters possess molar masses of from 500 to 100,000.

The carbonate-modified amphiphilic polymers described above are notable for good dispersibility in the washing liquor and good thermoplastic processability, making them particularly suitable for granulation in accordance with the method of the invention.

Other suitable polymers apart from the polyester compounds described include amphiphilic polymers that are obtainable, for example, by grafting acrylates, methacrylates, vinyl acetate and/or vinyl propionate onto water-soluble polyalkylene glycols.

Preferred inorganic solids employed are those which are constituents of current detergent formulations. Examples thereof are carbonates, sulfates, silicates, borates, phosphates of alkali metals and/or alkaline earth metals, zeolites, silicic acid or mixtures of these compounds. Examples of suitable silicates are zeolites or phyllosilicates, and also amorphous silicates and precipitated silicic acids. Particular preference is given to zeolites, sodium carbonate and sodium sulfate.

The granules produced in accordance with the method of the invention are of high mechanical stability. They are stable on storage and notable for the uniformity of the granular particles. Using the method of the invention it is possible to produce granules which have a high content of active substance and can nevertheless be processed further without difficulties after prolonged storage.

The granules produced in accordance with the method of the invention are used, for example, for producing modern detergents and cleaning products.

What is claimed is:

1. A method of granulating amphiphilic soil release polymers or mixtures of at least one amphiphilic soil release polymer and at least one inorganic solid by press agglomeration.

2. The method as claimed in claim 1, wherein one or more soil release polymers are granulated without the addition of an inorganic solid.

3. The granulation method as claimed in claim 1, wherein from 0.5 to <100% by weight of at least one amphiphilic soil release polymer and from >0 to 99.5% by weight of at least one inorganic solid are subjected to the press agglomeration.

4. The method as claimed in claim 1 or claim 2, wherein the press agglomeration is carried out in a circular or annular die press.

5. The method as claimed in claim 1 or claim 2, wherein the amphiphilic polymers employed are polyesters comprising terephthalic acid units.

6. The method as claimed in claim 1 or claim 2, wherein the polyester compounds employed comprise units of a) ethylene terephthalate and b) polyoxyethylene terephthalate of polyethylene glycols having molar masses M_{w} of 500-10,000.

7. The method as claimed in claim 1 or claim 2, wherein further additives are added to the mixture of amphiphilic polymers and/or of amphiphilic polymers and inorganic solids, these additives improving the dispersion of the granules in the washing process.

8. The method as claimed in claim 1, wherein inorganic solids are employed that are customarily a constituent of pulverulent detergents and cleaning products.

9. The method as claimed in claim 1 or claim 2, wherein the symmetrical granules obtained are rounded during or after granulation.

10. The use of pourable and free-flowing granular detergent constituents obtained as claimed in any one of claims 1 to 9 for producing solid, especially pulverulent, detergents and cleaning products and also laundry aftertreatment compositions.
